(19) United States
(12) Patent Application Publication
(10) Pub. No.: US 2009/0125749 A1
(43) Pub. Date: May 14, 2009

(54) Method and device for controlling a computer system

(76) Inventors: Reinhard Weiberle, Vaihingen/Enz (DE); Bernd Mueller, Gerlingen (DE); Yorck von Collani, Beilstein (DE); Rainer Gmehlich, Ditzingen (DE)

Correspondence Address: KENYON & KENYON LLP, ONE BROADWAY, NEW YORK, NY, 10004, US

(21) Appl. No.: 11/666,412

(22) PCT Filed: Oct. 25, 2005
(86) PCT No.: PCT/EP05/55548

§ 371 Date: Apr. 25, 2007

(30) Foreign Application Priority Data
Oct. 25, 2004 (DE) 10 2004 051 950.1
Oct. 25, 2004 (DE) 10 2004 051 992.7
Aug. 8, 2005 (DE) 10 2005 037 231.7

(51) Int. Cl. G06F 1/08

(52) U.S. Cl. 713/501

(57) ABSTRACT

A method and a device for controlling a computer system having at least two execution units, in particular for controlling a multiprocessor system having a switchover means via which a switchover is possible between at least two different operating modes of the computer system, a switchover of the clock frequency of the computer system also being performed when switching over between the operating modes.

### BACKGROUND INFORMATION

Transient errors triggered by alpha particles or cosmic radiation are increasingly becoming a problem for integrated semiconductor circuits. The ever smaller structure widths, lower voltages, and higher clock frequencies increase the likelihood of a change in charge caused by an alpha particle or cosmic radiation distorting a logical value in an integrated circuit. The result may be an incorrect calculation result. In safety-relevant systems, in particular in motor vehicles, such errors must therefore be reliably detected.

In safety-relevant systems such as in an ABS control system in a motor vehicle, for example, in which malfunctions of the electronic system must be reliably detected, redundancies are typically used for error detection in the corresponding control devices of such systems. Thus, for example, in known ABS systems, the complete microcontroller is duplicated, all ABS functions being redundantly calculated and checked for agreement. If a discrepancy of the results occurs, the ABS system is shut off.

A microcontroller essentially has memory modules (e.g., RAM, ROM, cache), a processor (CPU, core) and input/output interfaces known as peripherals (e.g., A/D transformer, CAN interface). Since memory elements may be effectively monitored using check codes (parity or ECC) and peripherals are monitored, according to the application, as part of a sensor or actuator signal path, duplicating only the core of a microcontroller represents an additional redundancy approach.

Such microcontrollers having at least two integrated cores are also known as dual-core architectures. The two cores execute the same program segment in a lockstep mode; the results of the two cores are compared, and an error may be detected during the comparison for agreement. This configuration of a dual-core system may be referred to as the comparison mode.

In other applications, dual-core architectures are also used for increasing performance. The two cores execute different programs, program segments, and instructions, thus making it possible to enhance system performance; therefore, this configuration of a dual-core system is known as the performance mode. This system is also known as a symmetrical multiprocessor system (SMP).

An extension of these systems entails using software to switch over between these two modes via access to a special address and specialized hardware devices. In the comparison mode the output signals of the cores are compared. In the performance mode the two cores work as a symmetrical multiprocessor system (SMP) and execute different programs, program segments, or instructions.

It is furthermore known from the related art that the clock frequency of a microcomputer may be modified even during operation. For example, current may be saved and thus power losses may be reduced by lowering the clock frequency. In a microcomputer which allows a switchover between two modes, there is the requirement, depending on the application, that the reliability characteristics must be strengthened for one mode. No method for achieving this is known from the related art.

It is therefore the object of the present invention to set the clock frequency of a multiprocessor system as needed either to reduce the power consumption, the electrical power loss, and the electromagnetic radiation or to reduce the susceptibility to errors.

### SUMMARY OF THE INVENTION

A method or a device for controlling a computer system having at least two execution units, a switchover between at least two different operating modes of the computer system being possible, has the advantage compared to known approaches that, when switching over between the operating modes, the clock frequency of the computer system is also switched over.

In selected applications it is advantageous that the clock frequency is higher in the comparison mode than in the performance mode. In other applications it may be advantageous in particular for the clock frequency to be higher in the performance mode than in the comparison mode. It may be furthermore advantageous that the ratio between the clock frequencies is selected such that an effective performance in the at least two operating modes is the same.

Furthermore, it is advantageous that at least one second clock frequency is generated by influencing a unit for clock rate modification and/or adjustment via a signal from a switchover means, in particular a switchover and comparison unit. It is also considered advantageous that a controllable PLL is used for generating at least one second clock frequency.

It is also advantageous that at least one second clock frequency is generated in that at least two independent devices for frequency adjustment are provided and a controlled switchover between the at least two output signals of these devices is possible. The switchover between the output signals of the at least two independent devices for frequency adjustment is advantageously controlled by a signal from the switchover means, in particular from a switchover and comparison unit.

Further advantages and advantageous embodiments of the present invention result from the features of the claims and the description.

### BRIEF DESCRIPTION OF THE DRAWING

FIG. 1 shows a multiprocessor system having two execution units H100a and H100b and a switchover and comparison unit H110.

FIG. 2 shows a multiprocessor system having two execution units H100a and H100b and two clock rate modifying units H210 and H220.

FIG. 3 shows a generic switchover and comparison component, also for use in more than two execution units.

FIG. 4 shows a generic switchover and comparison component, which generates a generic mode signal.

### DESCRIPTION OF THE DRAWING

The present invention describes a method in which the clock frequency switchover in a multiprocessor system is coupled to the switchover between the at least two operating modes of such a processor system.

The subject matter of the present invention is a multiprocessor system having at least two execution units and one switchover and comparison unit capable of switching over between the at least two operating modes “performance mode” and “comparison mode.” The overall performance of the processor system differs according to the operating mode that has been set.

In the following, an execution unit may denote either a processor/core/CPU or an FPU (floating point unit), DSP (digital signal processor), coprocessor, or ALU (arithmetic logical unit).

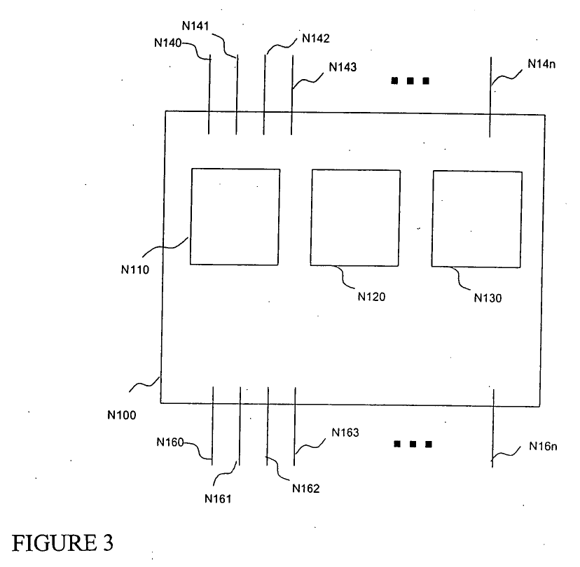

To illustrate the terms performance mode and comparison mode, FIG. 3 shows a generic case of a switchover and comparison component, also for use in more than two execution units. The n execution units take into account supply n signals N140, N14n to switchover and comparison component N100. These may generate up to n output signals N160, . . . , N16n from these input signals. In the simplest case, the “pure performance mode,” all signals N14i are passed onto the respective output signals N16i. In the opposite boundary case, the “pure comparison mode,” all signals N140, . . . , N14n are passed onto exactly one of output signals N16i.

This figure shows how the different conceivable modes may arise. For this purpose, this figure contains the logical components of a switching logic N110, which initially determines the number of output signals. Furthermore, switching logic N110 determines which of the input signals contribute to which of the output signals. One input signal may contribute to exactly one output signal. In mathematical form, formulated otherwise, the switching logic therefore defines a function which assigns one element of the set {N160, . . . , N16n} to each element of the set {N140, . . . , N14n}.

Processing logic N120 then determines for each of outputs N16i in which form the inputs contribute to this output signal. For example, to describe the different variation possibilities, let us assume, without prejudice to generality, that output N160 is generated by signals N141, . . . , N14m. If m=1, this simply corresponds to switching through the signal; if m=2, signals N141, N142 are compared. This comparison may be performed synchronously or asynchronously; it may be performed by bits or only on significant bits or also using a tolerance band.

If m≧3, there are several possibilities.

A first possibility includes comparing all signals and, if at least two different values are present, detecting an error which may be optionally signaled.

A second possibility includes making a k out of m selection (k>m/2). This may be implemented by the use of comparators. An error signal may optionally be generated if one of the signals is recognized as being different. A possibly different error signal may be generated if all three signals are different.

A third possibility is supplying these values to an algorithm, which may represent, for example, the formation of a mean value, a median value, or the use of an error-tolerant algorithm (ETA). Such an ETA depends on rejecting extreme values of the input values and performing some kind of averaging of the remaining values. This averaging may be performed on the entire set of remaining values or, preferably, on a subset to be easily formed in hardware. In this case it is not always necessary to actually compare the values. During averaging, for example, only addition and division must be performed; ETM, ETA, or median require partial sorting. If necessary, also in this case an error signal may be optionally output in the event of sufficiently large extreme values.

These different possibilities mentioned above for processing multiple signals to form one signal are referred to as comparison operations for short. The function of the processing logic is therefore to establish the exact configuration of the comparison operation for each output signal and thus also for the corresponding input signals. The combination of the information of switching logic N110 (i.e., the above-mentioned function) and the processing logic (i.e., establishing the comparison operation for each output signal, i.e., for each function value) is the mode information, which determines the mode. In the general case, this information is, of course, multi-valued, i.e., cannot be represented via a logical bit. Not all theoretically conceivable modes are useful in a given implementation; the number of allowed modes is preferably limited. It should be pointed out that in the case of only two execution units, where there is only one comparison mode, all the information may be condensed onto only one logical bit. A switchover from a performance mode to a comparison mode is characterized in general by execution units, which are mapped onto different outputs in the performance mode, being mapped onto the same output in the comparison mode. This is preferably implemented by the presence of a subsystem of execution units, in which in the performance mode all input signals N14i, which are to be taken into account in the subsystem, are switched directly onto the corresponding output signals N16i, while in the comparison mode all are mapped onto one output. Alternatively, such a switchover may also be implemented by modifying pairings. It is represented by the impossibility in the general case of referring to a performance mode and comparison mode, although in a given embodiment of the present invention the set of allowed modes may be limited in such a way that this becomes possible. However, it is always possible to refer to a switchover from the performance mode to the comparison mode (and vice-versa).

A switchover between these modes may be controlled by software and may take place dynamically during operation. The switchover is triggered either by the execution of special switchover instructions, special instruction sequences, explicitly marked instructions, or by access to certain addresses by at least one of the execution units of the multiprocessor system.

Error switching logic N130 collects the error signals and may switch outputs N16i to passive, for example, by interrupting them via a switch.

In a first preferred exemplary embodiment, the clock frequency of the processor system is switched over in such a way that the effective performance available to the user remains the same (or comparable within certain limits) regardless of the operating mode. For this purpose, when switching over from the performance mode to the comparison mode, the clock frequency must be increased exactly by the factor by which the performance in the performance mode would increase compared to the comparison mode without switching over the clock frequency.

P_{E}=P_{A,V}=P_{A,P}*f_{P}/f_{V}

where P_{E}=effective performance (usable by the user)
P_{A,P}=original performance in the performance mode
P_{A,V}=original performance in the comparison mode
f_{V}=clock frequency in the comparison mode
f_{P}=clock frequency in the performance mode

The essential advantage of this application is that the effective performance usable for the user remains the same, i.e., regardless of the mode. In such a configuration, a performance mode does not result in higher effective performance of the processor system, but in lower power consumption and noise radiation at the same performance compared to operation in a comparison mode. Depending on the system design, a higher clock rate, within certain limits, is also conceivable. While this may potentially result in higher susceptibility to transient errors (EMC, capacitive coupling), excellent error detection may be achieved at the same time in the comparison mode. This advantage may be used in particular for solving scheduling problems, since a scheduling algorithm always needs execution times, which, in this exemplary embodiment, are independent of the assignment to a mode. This makes a more flexible and more modular platform strategy in software development possible.

In a second exemplary embodiment, an exactly opposite assignment is proposed. Susceptibility to transient errors (e.g., brief interference pulses of the voltage source, soft errors) is reduced by a lower clock frequency. If the comparison mode is operated using a reduced clock frequency, the execution of the program portions in this operating mode is less susceptible to errors, i.e., sturdier compared to an embodiment having a higher clock frequency. Program portions calculated in lockstep mode (comparison mode) require enhanced error detection according to the specifications. In the present exemplary embodiment, error detection is enhanced (security aspect) and also the likelihood of the occurrence of errors is potentially reduced (enhanced reliability and security).

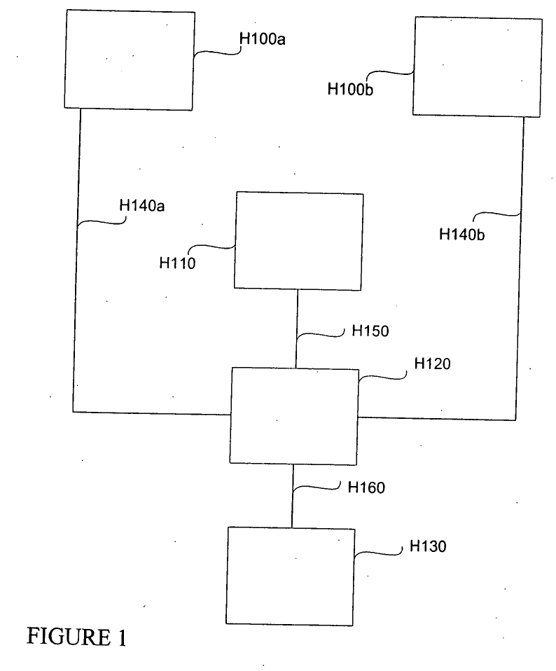

FIG. 1 shows a multiprocessor system having two execution units H100a and H100b and a switchover and comparison unit H110. Switchover and comparison unit H110 generates a mode signal H150, which is used by a clock rate modifying unit H120 to modify clock rate H160 of clock rate generating unit H130 in such a way that when switching over into comparison mode the clock frequency is increased by exactly the factor by which performance would be increased in the performance mode compared to the comparison mode without switching over the clock frequency. When switching over from a performance mode to a comparison mode, the clock frequency is reduced by exactly the corresponding factor. Adjusted clock rate H140a, H140b is then made available to the other units, in particular to execution units H100a and H100b. Clock rate generator unit H130 may be a PLL (phase-locked loop) or a clock divider which may modify a base clock rate of a clock rate generator unit H130 (for example, RC resonator or quartz) in a known manner.

In a second configuration, clock rate modifying unit H120 reduces the clock rate when switching over from the performance mode to the comparison mode. This then results in reduced sensitivity to transient errors in the comparison mode. Accordingly, the clock rate is increased again when switching over from the comparison mode to the performance mode.

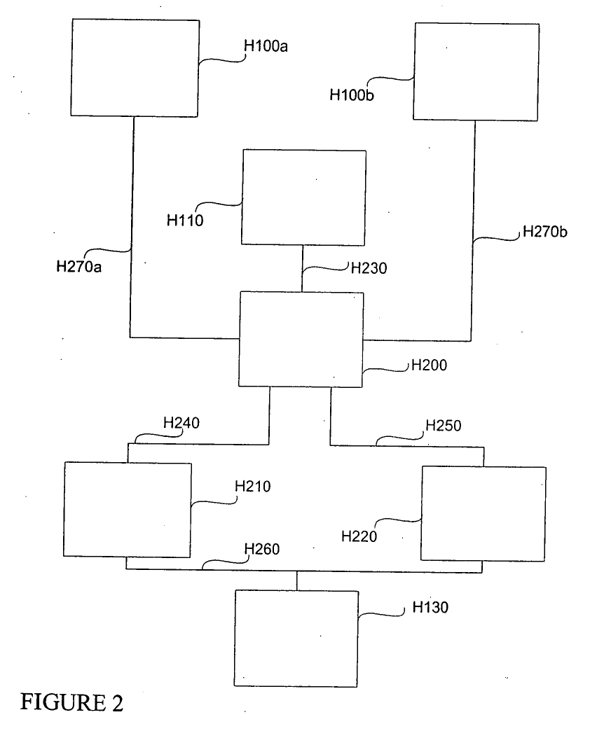

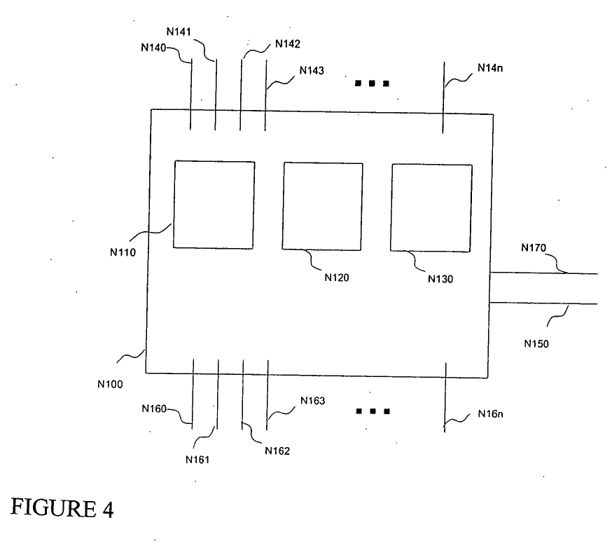

Mode signal H150 is shown in FIG. 4 in a generic form. The signals and components N110, N120, N130, N140, N141, N142, N143, N14n, N160, N161, N162, N163, N16n of switchover and comparison component N200 have the same meaning as in switchover and comparison component N100 in FIG. 3. In addition, mode signal N150 and error signal N170 are shown in this figure. Mode signal N150 corresponds to signal H150 of FIGS. 1 and 2. Optional error signal N170 is generated by error switching logic N130, which collects the error signals, and is either a direct relaying of the individual error signals or a bundling of the error information contained therein. Mode signal N150 is optional but may be advantageously used outside this component at several locations. The combination of the information of switching logic N110 (i.e., the above-mentioned function) and the processing logic (i.e., determining the comparison operation for each output signal, i.e., for each function value) is the mode information, which determines the mode. In the general case, this information is, of course, multi-valued, i.e., cannot be represented via one logical bit. Not all theoretically conceivable modes are meaningful in a given implementation; the number of allowed modes is preferably limited. The mode signal then takes the relevant mode information to the outside. Hardware implementation is preferably presented in such a form that the externally visible mode signal may be configured. The processing logic and the switching logic also preferably have a configurable design. These configurations are preferably adjusted to one another. Alternatively, modifications of the mode signal may also, only or additionally, be supplied to the outside. This is advantageous, in particular in a dual configuration.

FIG. 2 shows an alternative using two clock rate modifying units H210 and H220. The two execution units H100a and H100b receive their clock rates H270a, H270b from clock switchover unit H200, which switches over the clock rate as a function of a core mode signal H150 generated by a switchover and comparison unit H110. Clock switchover unit H200 has two clock inputs which are driven by clock H240 and H250. Clock H240 is set by clock rate modifying unit H210; clock H250 is set by clock rate modifying unit H220. Clock rate modifying units H210 and H220 optionally receive a base clock signal H260 from clock generator unit H130; otherwise they receive separate clock signals. This system may be used for reducing the clock rate for the execution units in the performance mode so that the performance remains approximately the same in both modes. This system may also be used for reducing the clock rate in the comparison mode in order to reduce the sensitivity to transient errors in the comparison mode.

1-16. (canceled)

17. A method for controlling a multiprocessor computer system having at least two execution units, a switchover being possible between at least two different operating modes of the computer system, the method comprising:
performing a switchover of a clock frequency of the computer system with the switchover between the operating modes.

18. The method as recited in claim 17, wherein the at least two different operating modes includes a comparison mode and a performance mode, and wherein a clock frequency in the comparison mode is higher than a clock frequency in the performance mode.

19. The method as recited in claim 17, wherein the at least two different operating modes includes a comparison mode and a performance mode, and wherein a clock frequency in the performance mode is higher than a clock frequency in the comparison mode.

20. The method as recited in claim 17, wherein a ratio between clock frequencies is selected such that an effective performance in the at least two operating modes is the same.

21. The method as recited in claim 17, wherein at least one second clock frequency is generated by at least one of: i) influencing a unit for clock rate modification, and ii) adjustment via a signal from a switchover device.

22. The method as recited in claim 21, wherein the at least one second clock frequency is generated by adjustment via a signal from a switchover and comparison unit.

23. The method as recited in claim 22, wherein a controllable PLL is used for generating the at least one second clock frequency.

24. The method as recited in claim 17, wherein at least one second clock frequency is generated in that at least two independent devices are provided for frequency adjustment, and a controlled switchover between the at least two output signals of these devices is possible.

25. The method as recited in claim 24, wherein the switchover between the output signals of the at least two independent devices for frequency adjustment is controlled by a signal from a switchover device.

26. The method as recited in claim 26, wherein the switchover device is a switchover and comparison unit.

27. A device for controlling a multiprocessor computer system having at least two execution units, comprising:
a switchover device configured to perform a switchover between at least two different operating modes of the computer system,
wherein the device is configured so that a switchover of clock frequency of the computer system is performed with the switchover between the operating modes.

28. The device as recited in claim 27, wherein the at least two different operating modes include a comparison mode and performance mode, and wherein the device is configured so that a clock frequency in the comparison mode is higher than a clock frequency in the performance mode.

29. The device as recited in claim 27, wherein the device is configured so that a clock frequency in the performance mode is higher than a clock frequency in the comparison mode.

30. The device as recited in claim 27, wherein the device is configured so that a ratio between clock frequencies is selected such that an effective performance in the at least two operating modes is the same.

31. The device as recited in claim 27, further comprising:
a unit configured to at least one of modify and adjust a clock rate, wherein at least one second clock frequency is generated by influencing the unit via a signal from the switchover device.

32. The device as recited in claim 31, wherein the unit is a PLL configured to generate the at least one second frequency.

33. The device as recited in claim 27, further comprising:
at least two independent devices configured for frequency adjustment, wherein a controlled switchover between at least two output signals of independent devices occurs via the switchover device.

34. A computer system, comprising:
at least two execution units; and
a switchover device configured to perform a switchover between at least two different operating modes of the at least two execution units, wherein a switchover of clock frequency is performed with the switchover between the at least two different operating modes.
